(19) United States
(12) Patent Application Publication
(10) Pub. No.: US 2023/0281108 A1
(43) Pub. Date: Sep. 7, 2023

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: Fujitsu Limited, Kawasaki-shi (JP)

(72) Inventors: Naoaki ONO, Nagoya (JP); Tokutomi NAGAO, Tsushima (JP); Takanobu KAKIUCHI, Takasago (JP); MASASHI KATOU, Nagoya (JP); Kazuyuki TANAKA, Kasugai (JP); Kazunari Fujita, Nagoya (JP)

(73) Assignee: Fujitsu Limited, Kawasaki-shi (JP)

(21) Appl. No.: 18/068,054

(22) Filed: Dec. 19, 2022

(30) Foreign Application Priority Data
Mar. 1, 2022 (JP) 2022-031299

(51) Int. Cl. G06F 11/36

(52) U.S. Cl. CPC G06F 11/364

(57) ABSTRACT

A non-transitory computer-readable recording medium storing an information processing program for causing a computer to execute a procedure, the procedure includes acquiring a start time and an end time of an event processed by a process forming software in which a fault has occurred from a storage, detecting any event in which a processing time is unusual, the any event being processed by any process forming the software, and identifying, when the any event is detected, a type of data related to the any process corresponding to cause of an unusual processing time of the detected any event, based on a state of the any process.

### CROSS-REFERENCE TO RELATED APPLICATION

This application is based upon and claims the benefit of priority of the prior Japanese Patent Application No. 2022-31299, filed on Mar. 1, 2022, the entire contents of which are incorporated herein by reference.

### FIELD

The embodiments discussed herein are related to a computer-readable recording medium storing an information processing program, an information processing method, and an information processing apparatus.

### BACKGROUND

In a case where a fault occurs in middleware, a person in charge of an operation uses a collection command to collect investigation material related to the middleware and provide the investigation material to a person in charge of the investigation. Examples of the investigation material include an operation log of an operating system (OS), an operation log of middleware, an operation log of a process forming the middleware, and the like. Next, the person in charge of the investigation identifies the cause of the fault in the middleware by reference to the provided investigation material, and notifies the person in charge of the operation of the cause. The person in charge of the operation handles the notified cause of the fault.

As a related art, for example, there is a technique in which stack information of an application recorded in a memory at a predetermined stack collection interval is analyzed, and a stall is detected from a user task execution time or the number of stack outputs for each method. For example, there is a technique for acquiring trace information of a set first target process. For example, even when events continuously occur in a processing program within an event handling processing time period, there is a technique for detecting an unusual processing program by monitoring the time period during which the processing program continues to be executed.

Japanese Laid-open Patent Publication No. 2009-187189, International Publication No. 2010/018619, and Japanese Laid-open Patent Publication No. 2000-105707 are disclosed as related art.

### SUMMARY

According to an aspect of the embodiments, a non-transitory computer-readable recording medium storing an information processing program for causing a computer to execute a procedure, the procedure includes acquiring a start time and an end time of an event processed by a process forming software in which a fault has occurred from a storage, detecting any event in which a processing time is unusual, the any event being processed by any process forming the software, and identifying, when the any event is detected, a type of data related to the any process corresponding to cause of the unusual processing time of the detected any event, based on a state of the any process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system;

FIG. 3 is a block diagram illustrating a hardware configuration example of an information processing apparatus;

FIG. 4 is a block diagram illustrating a functional configuration example of the information processing apparatus;

FIG. 5 is a block diagram illustrating a functional configuration example of the information processing system;

FIG. 6 is an explanatory diagram (part 1) illustrating an operation example of the information processing apparatus;

FIG. 7 is an explanatory diagram (part 2) illustrating the operation example of the information processing apparatus;

FIG. 8 is an explanatory diagram (part 3) illustrating the operation example of the information processing apparatus;

FIG. 9 is an explanatory diagram (part 4) illustrating the operation example of the information processing apparatus;

FIG. 10 is a flowchart illustrating an example of an event processing procedure;

FIG. 11 is a flowchart illustrating an example of a collection control processing procedure;

FIG. 12 is a flowchart (part 1) illustrating an example of a state determination processing procedure;

FIG. 13 is a flowchart (part 2) illustrating the example of the state determination processing procedure;

FIG. 14 is a flowchart illustrating an example of a first collection processing procedure;

FIG. 15 is a flowchart illustrating an example of a second collection processing procedure; and

FIG. 16 is a flowchart illustrating an example of a third collection processing procedure.

### DESCRIPTION OF EMBODIMENTS

In the related art, there is a problem that a processing load for identifying the cause of the fault is likely to increase. For example, depending on the type of fault, the types of appropriate investigation materials that make it possible to identify the cause of the fault are different, and it is difficult to determine what types of investigation materials are to be collected. By contrast, collecting all different types of investigation materials leads to an increase in the processing load and the processing time taken to identify the cause of the fault.

Hereinafter, embodiments of techniques capable to reduce a processing load when the cause of fault is identified will be described in detail with reference to the drawings.

[Example of Information Processing Method According to Embodiment]

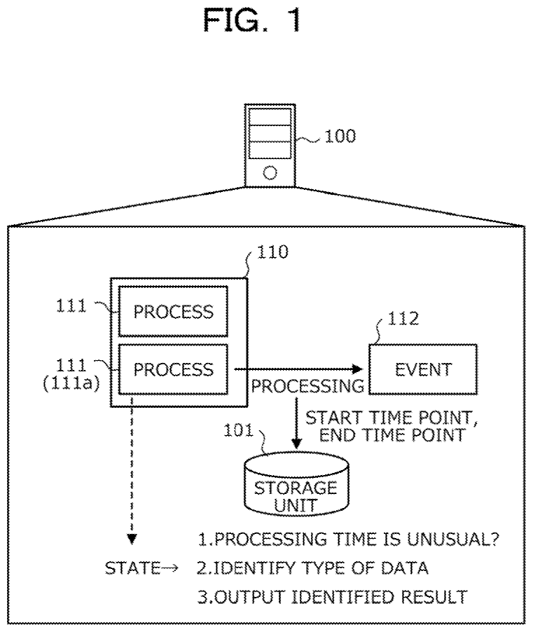

FIG. 1 is an explanatory diagram illustrating an example of an information processing method according to an embodiment. An information processing apparatus 100 is a computer capable of reducing a processing load for identifying a cause of a fault in software. For example, the software is middleware. For example, the middleware is related to tasks. For example, the middleware is software for executing a job. For example, the middleware may be software for monitoring the system.

In an environment in which the middleware is executed, patch application to an OS, introduction of antivirus software, introduction of other middleware, update of other middleware, or the like may be performed. In this case, performance, behavior, or the like of an application programming interface (API) of the OS may change, and an operation of a process that forms the middleware may change. As a result, a fault may occur in the middleware.

There has been a problem in that the processing load for identifying the cause of the fault in middleware is likely to increase. For example, depending on the type of fault, the types of appropriate investigation materials that make it possible to identify the cause of the fault are different, and it is difficult to determine what types of investigation materials are to be collected.

Accordingly, in some cases, the person in charge of an operation may not provide the person in charge of an investigation with appropriate investigation materials that make it possible to identify the cause of the fault in the middleware. In this case, although the person in charge of the investigation may not identify the cause of the fault in the middleware even by reference to the provided investigation material, the person in charge of the investigation may investigate the cause of the fault in the middleware by reference to the provided investigation material. For example, in some cases, the person in charge of the investigation may not identify the cause of the fault in the middleware even by reference to investigation materials including an operation log of the OS, an operation log of the middleware, an operation log of the process forming the middleware, or the like. For this reason, the work load and the work time on the person in charge of the investigation may be easily increased.

When the person in charge of the investigation is unable to identify the cause of the fault, the person in charge of the investigation instructs the person in charge of the operation to collect another investigation material that makes it possible to identify the cause of the fault in the middleware. For example, it is conceivable that the person in charge of the investigation may suspect that the state of the process forming the middleware is an operation delay or loop, and instruct the person in charge of the operation to collect other investigation material including trace information of the process. It is conceivable that the person in charge of the investigation may suspect that the state of the process forming the middleware is a stop or an unusual end and instruct the person in charge of the operation to collect other investigation material including a dump file of the process. The person in charge of the operation collects other investigation material that makes it possible to identify the cause the fault in the middleware. For this reason, the work load and the work time on the person in charge of the operation may be easily increased.

An environment in which the middleware is executed is a target from which the investigation material is collected a plurality of times. For this reason, the processing load and the processing time for the environment in which the middleware is executed may be easily increased. When the processing load and the processing time for the environment in which the middleware is executed increase, a task using the middleware is likely to be adversely affected.

By contrast, when the fault occurs in the middleware, a method of collecting all the different types of investigation materials is conceivable. This method even leads to an increase in the processing load and the processing time taken to identify the cause of the fault. The processing load and the processing time for the environment in which the middleware is executed may be easily increased. The person in charge of the investigation refers to all the different types of investigation materials. For this reason, the work load and the work time on the person in charge of the investigation may be easily increased. The volume of data of the investigation materials may be easily increased.

Although it is conceivable to narrow down the types of investigation materials to be collected in accordance with the state of the process, it is difficult to identify the state of the process with high accuracy. For this reason, it is difficult to narrow down the types of investigation materials to be collected, reduce the work load and the work time on the person in charge of the operation and the person in charge of the investigation, and reduce the processing load and the processing time for the environment in which the middleware is executed.

For example, even with reference to Japanese Laid-open Patent Publication No. 2009-187189 described above, it is difficult to identify whether the state of the process is the stop, the loop, or the like. Accordingly, even with reference to the above-described Japanese Laid-open Patent Publication No. 2009-187189, it is not possible to change the type of the investigation material to be collected in accordance with the state of the process such that the dump file is collected when the state of the process is in the stop and the trace information is collected when the state of the process is the loop.

For example, even with reference to International Publication No. 2010/018619 described above, it is difficult to determine whether the state of the process is the operation delay, the loop, or the like, in addition to identify whether or not the process is in a running state. Accordingly, even with reference to International Publication No. 2010/018619 described above, it is not possible to change the type of the investigation material to be collected in accordance with the state of the process.

For example, even with reference to Japanese Laid-open Patent Publication No. 2000-105707 described above, it is difficult to identify whether the state of the process is the operation delay, the stop, the loop, or the like. Accordingly, even with reference to the above-described Japanese Laid-open Patent Publication No. 2000-105707, it is not possible to change the type of the investigation material to be collected in accordance with the state of the process such that the dump file is collected when the state of the process is in the stop and the trace file is collected when the state of the process is the operation delay. Even when the process is operating normally, in a case where the processing time of the process changes relatively greatly, it is difficult to determine whether or not the state of the process is unusual.

As described above, even when Japanese Laid-open Patent Publication No. 2009-187189, International Publication No. 2010/018619, and Japanese Laid-open Patent Publication No. 2000-105707 described above are combined, it is not possible to change the type of the investigation material to be collected in accordance with the state of the process. Accordingly, in the present embodiment, an information processing method will be described with which it is possible to change the type of the investigation material to be collected in accordance with the state of the process, and it is possible to reduce the processing load when identifying the cause of the fault in the middleware.

As illustrated in FIG. 1, the information processing apparatus 100 includes a storage unit 101. The storage unit 101 stores a start time point and an end time point of an event 112 processed by a process 111 forming the middleware 110. When there is the unusual process, the end time point may not be stored in the storage unit 101. For example, a fault may be caused by the unusual process in the middleware 110. For example, one or a plurality of processes 111 is present.
(1-1) The information processing apparatus 100 detects, by reference to the storage unit 101, any event 112 in which the processing time is unusual among the events 112 processed by the respective processes 111 forming the middleware 110. The unusual processing time is, for example, that the end time point is not stored in the storage unit 101. The unusual processing time is, for example, that the end time point is not stored in the storage unit 101 and an elapsed time from the start time point stored in the storage unit 101 to a current time point exceeds a threshold. For example, the information processing apparatus 100 detects the event 112 processed by a process 111a in which the end time point is not stored in the storage unit 101 and the elapsed time from the start time point stored in the storage unit 101 to the current time point exceeds the threshold.

Accordingly, the information processing apparatus 100 may identify the process 111a that has processed the event 112 in which the processing time is unusual. At the time of investigating the cause of the fault in the middleware 110, the information processing apparatus 100 may determine which one of the processes 111 forming the middleware 110 is preferable to collect data. For example, the information processing apparatus 100 may determine that it is preferable to collect data on the process 111a among the processes 111 forming the middleware 110.
(1-2) In a case where the event 112 is detected, the information processing apparatus 100 identifies the type of data related to the process 111a, corresponding to the cause of the unusual processing time of the event 112, based on the state of the process 111a having processed the event 112. For example, the information processing apparatus 100 searches for information indicating the state of the process 111a that has processed the detected event 112 from a predetermined storage area that stores information indicating the state of the process 111. The information indicating the state of the process 111 is managed by the OS, for example.

For example, when the information indicating the state of the process 111a is not found, the information processing apparatus 100 determines the cause of the unusual processing time of the detected event 112=the unusual end, and identifies the type of data related to the process 111a=the dump file, corresponding to the unusual end. The dump file is, for example, a dump file saved by the OS.

For example, when the information indicating the state of the process 111a is found, the information processing apparatus 100 acquires the information indicating the state of the process 111a. For example, when the acquired information indicates the state of the process 111a=the stop, the information processing apparatus 100 determines the cause of the unusual processing time of the detected event 112=the stop, and identifies the type of data related to the process 111a corresponding to the stop=the dump file. The dump file is a dump file of the process 111a.

For example, when the acquired information does not indicate the state of the process 111a=the stop, the information processing apparatus 100 determines the cause of the unusual processing time of the detected event 112=the operation delay or the loop. For example, the information processing apparatus 100 identifies the type of data related to the process 111a, corresponding to the operation delay or the loop=the trace information.
(1-3) The information processing apparatus 100 outputs the identified result so that the user may refer to the identified result. The user is, for example, a person in charge of the operation or the like. Accordingly, the information processing apparatus 100 may reduce the processing load for identifying the cause of the fault in the middleware 110. For example, the information processing apparatus 100 may enable the user to determine what kind of investigation material is to be collected. For example, the information processing apparatus 100 may enable the user to collect an appropriate investigation material that enables the user to identify the cause of the fault in the middleware 110. For this reason, the information processing apparatus 100 may reduce the work load and the work time on the user, and may reduce the processing load and the processing time for the environment in which the middleware 110 is executed.

Based on the identified result, the information processing apparatus 100 may collect data related to the process 111a of the identified type and output the data so that the user may refer to the information. Examples of the user include a person in charge of the operation, a person in charge of the investigation, or the like. Accordingly, the information processing apparatus 100 may reduce the processing load for identifying the cause of the fault in the middleware 110. For example, the information processing apparatus 100 enables the user to use the appropriate investigation material that enables the user to identify the cause of the fault in the middleware 110. For this reason, the information processing apparatus 100 may reduce the work load and the work time on the user, and may reduce the processing load and the processing time for the environment in which the middleware 110 is executed.

[Example of Information Processing System 200]

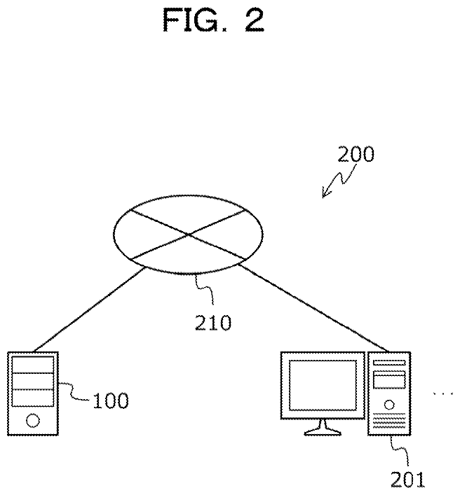

Next, an example of an information processing system 200 to which the information processing apparatus 100 illustrated in FIG. 1 is applied will be described by using FIG. 2.

FIG. 2 is an explanatory diagram illustrating an example of the information processing system 200. Referring to FIG. 2, the information processing system 200 includes the information processing apparatus 100 and a client apparatus 201.

In the information processing system 200, the information processing apparatus 100 and the client apparatus 201 are coupled to each other via a wired or wireless network 210. The network 210 is, for example, a local area network (LAN), a wide area network (WAN), the Internet, or the like.

The information processing apparatus 100 is a computer that realizes an environment in which middleware is executed. Along with starting the OS, the information processing apparatus 100 starts and executes the middleware. In response to reception of the middleware start-up instruction from the client apparatus 201, the information processing apparatus 100 may start and execute the middleware. For example, the information processing apparatus 100 processes a generated event by each of one or more processes that form the middleware.

The information processing apparatus 100 includes a storage unit in which a start time point and an end time point of the event are stored. The information processing apparatus 100 stores the start time point of the event in the storage unit according to the start of the event. The information processing apparatus 100 stores the end time point of the event in the storage unit according to the end of the event. When there is the unusual process, the end time point of the event may not be stored in the storage unit.

In response to reception of an instruction to collect the investigation material from the client apparatus 201, the information processing apparatus 100 detects, by reference to the storage unit, any event in which the processing time is unusual among events processed by respective processes forming the middleware. In a case where the event is detected, the information processing apparatus 100 identifies, based on the state of a process that has processed the event, a type of data related to the process, corresponding to the cause of the unusual processing time of the event.

Based on the identified result, the information processing apparatus 100 collects the identified type of data related to the process that has processed the detected event. The information processing apparatus 100 transmits the collected data to the client apparatus 201. The information processing apparatus 100 is, for example, a server, a personal computer (PC), or the like.

The client apparatus 201 is a computer used by a user. Examples of the user include a person in charge of the operation, a person in charge of the investigation, or the like. Based on an operation input by the user, the client apparatus 201 transmits an instruction to start the middleware to the information processing apparatus 100. Based on an operation input by the user, the client apparatus 201 transmits an instruction to collect the investigation material to the information processing apparatus 100.

The client apparatus 201 receives the collected data from the information processing apparatus 100. The client apparatus 201 outputs the received data so that the user may refer to the data. The client apparatus 201 is, for example, a PC, a tablet terminal, a smartphone, or the like.

Although the case where the information processing apparatus 100 and the client apparatus 201 are different apparatus has been described above, the embodiment is not limited thereto. For example, there may be a case where the information processing apparatus 100 has the functions as the client apparatus 201 and operates as the client apparatus 201 as well.

[Hardware Configuration Example of Information Processing Apparatus 100]

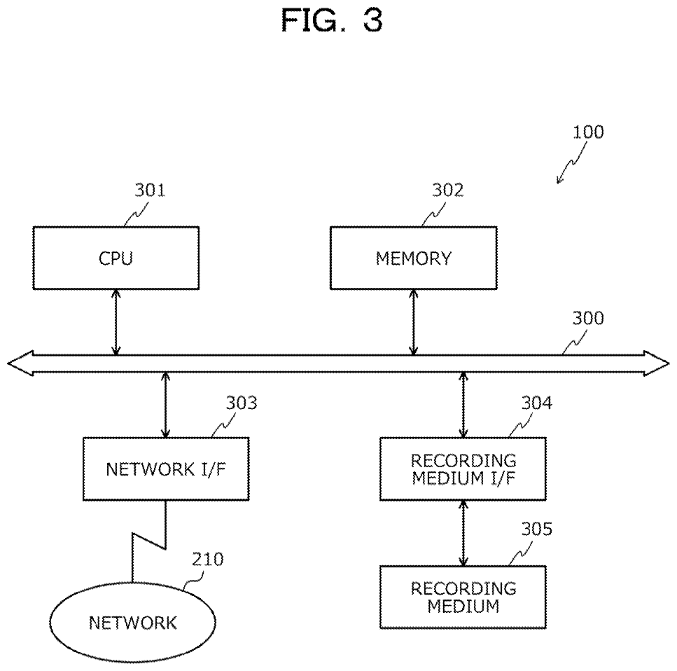

Next, a hardware configuration example of the information processing apparatus 100 will be described by using FIG. 3.

FIG. 3 is a block diagram illustrating a hardware configuration example of the information processing apparatus 100. In FIG. 3, the information processing apparatus 100 includes a central processing unit (CPU) 301, a memory 302, a network interface (I/F) 303, a recording medium I/F 304, and a recording medium 305. These components are coupled to each other through a bus 300.

The CPU 301 controls the entire information processing apparatus 100. The memory 302 includes, for example, a read-only memory (ROM), a random-access memory (RAM), a flash ROM, and the like. For example, the flash ROM or the ROM stores various programs, and the RAM is used as a work area for the CPU 301. When loaded by the CPU 301, the program stored in the memory 302 causes the CPU 301 to execute coded processing.

The network I/F 303 is coupled to the network 210 through a communication line, and is coupled to another computer via the network 210. The network I/F 303 controls the network 210 and an internal interface, and controls inputs and outputs of data from and to another computer. The network I/F 303 is, for example, a modem, a LAN adapter, or the like.

The recording medium I/F 304 controls reading/writing of data for the recording medium 305 under the control of the CPU 301. The recording medium I/F 304 is, for example, a disk drive, a solid-state drive (SSD), a Universal Serial Bus (USB) port, or the like. The recording medium 305 is a nonvolatile memory that stores data written under the control of the recording medium I/F 304. The recording medium 305 is, for example, a disk, a semiconductor memory, a USB memory, or the like. The recording medium 305 may be removably attached to the information processing apparatus 100.

In addition to the components described above, the information processing apparatus 100 may include, for example, a keyboard, a mouse, a display, a printer, a scanner, a microphone, a speaker, and so on. The information processing apparatus 100 may include a plurality of the recording medium I/Fs 304 and a plurality of the recording media 305. The information processing apparatus 100 does not have to include the recording medium I/F 304 and the recording medium 305.

[Hardware Configuration Example of Client Apparatus 201]

For example, a hardware configuration example of the client apparatus 201 is similar to the hardware configuration example of the information processing apparatus 100 illustrated in FIG. 3, thus, the description thereof is omitted herein.

[Functional Configuration Example of Information Processing Apparatus 100]

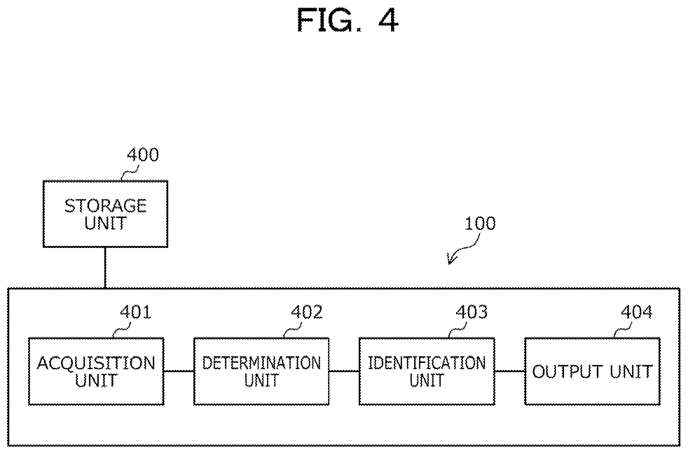

Next, a functional configuration example of the information processing apparatus 100 will be described by using FIG. 4.

FIG. 4 is a block diagram illustrating a functional configuration example of the information processing apparatus 100. As illustrated in FIG. 4, the information processing apparatus 100 includes a storage unit 400, an acquisition unit 401, a determination unit 402, an identification unit 403, and an output unit 404.

The storage unit 400 is implemented by, for example, a storage area such as the memory 302 or the recording medium 305 illustrated in FIG. 3. Hereinafter, a case where the storage unit 400 is included in the information processing apparatus 100 will be described, but the embodiment is not limited thereto. For example, there may be a case where the storage unit 400 is included in an apparatus different from the information processing apparatus 100 and the information processing apparatus 100 is allowed to refer to memory content stored in the storage unit 400.

The acquisition unit 401 to the output unit 404 function as an example of a control unit. For example, functions of the acquisition unit 401 to the output unit 404 are implemented by causing the CPU 301 to execute a program stored in the storage area such as the memory 302 or the recording medium 305 illustrated in FIG. 3 or by using the network I/F 303. A processing result by each functional unit is stored in, for example, a storage area such as the memory 302 or the recording medium 305 illustrated in FIG. 3.

The storage unit 400 stores various kinds of information to be referred to or updated in processing performed by the functional units. The storage unit 400 stores a start time point and an end time point of an event processed by a process forming software. For example, the software is middleware. The end time point may not be stored in the storage unit 400 when there is the unusual process. For example, the storage unit 400 stores the start time point and the end time point of an event in association with an attribute of the event. The attribute is, for example, an event name. For example, the attribute may be a combination of the event name and an event argument. For example, the start time point is acquired by the acquisition unit 401. For example, the end time point is acquired by the acquisition unit 401.

The storage unit 400 stores a first threshold. The first threshold is a threshold that serves as a criterion for determining the unusual event processing time. The first threshold may be fixed. The first threshold may be variable. For example, the first threshold is set by the determination unit 402. For example, the first threshold may be acquired by the acquisition unit 401. For example, the first threshold may be stored in the storage unit 400 in advance.

The storage unit 400 stores a second threshold. The second threshold is a threshold that serves as a criterion for determining the unusual event processing time. The second threshold may be the same as the first threshold. The second threshold may be fixed. The second threshold may be variable. For example, the second threshold is set by the determination unit 402. For example, the second threshold may be acquired by the acquisition unit 401. For example, the second threshold may be stored in the storage unit 400 in advance.

The acquisition unit 401 acquires various kinds of information for use in processing performed by the functional units. The acquisition unit 401 stores the acquired various kinds of information in the storage unit 400 or outputs the acquired various kinds of information to the functional units. The acquisition unit 401 may output the various kinds of information stored in the storage unit 400 to the functional units. For example, the acquisition unit 401 acquires various kinds of information based on operation inputs by a user. Examples of the user include a person in charge of the operation, a person in charge of the investigation, or the like. For example, the acquisition unit 401 may receive the various kinds of information from an apparatus different from the information processing apparatus 100.

Upon detecting that the process forming the middleware has started processing the event, the acquisition unit 401 stores the start time point of the event in the storage unit 400 in association with the attribute of the event. The attribute is, for example, an event name. For example, the attribute may be a combination of the event name and an event argument.

Upon detecting that the process forming the middleware has finished processing the event, the acquisition unit 401 stores the end time point of the event in the storage unit 400 in association with the attribute of the event. The attribute is, for example, an event name. For example, the attribute may be a combination of the event name and an event argument.

The acquisition unit 401 acquires the first threshold. For example, the acquisition unit 401 acquires the first threshold by receiving an input of the first threshold based on an operation input of the user. Alternatively, the acquisition unit 401 may acquire the first threshold by receiving the first threshold from another computer.

The acquisition unit 401 acquires the second threshold. For example, the acquisition unit 401 acquires the second threshold by receiving an input of the second threshold based on an operation input of the user. Alternatively, the acquisition unit 401 may acquire the second threshold by receiving the second threshold from another computer.

The acquisition unit 401 may receive a start trigger for any functional unit to start processing. The start trigger is, for example, a predetermined operation input by the user. For example, the start trigger may be a reception of predetermined information from another computer. For example, the start trigger may also be an output of predetermined information from any functional unit.

For example, the acquisition unit 401 acquires a determination request based on an operation input by the user. For example, the determination request may include specification of the middleware. For example, the acquisition unit 401 may receive the acquisition of the determination request as a start trigger for starting the processing of the determination unit 402 and the identification unit 403. For example, the acquisition unit 401 may receive the arrival of a predetermined timing as a start trigger for starting the processing of the determination unit 402 and the identification unit 403. The predetermined timing is, for example, a timing at regular time intervals. For example, the predetermined timing is a specified point in time per day.

The determination unit 402 sets the first threshold based on a processing time corresponding to a difference between the start time point and the end time point of a past event whose end time point is stored in the storage unit 400. For example, the determination unit 402 sets, for each attribute of an event, the first threshold based on a processing time corresponding to the difference between the start time point and the end time point of a past event of the attribute other than a latest event of the attribute. The attribute is, for example, an event name. For example, the attribute may be a combination of the event name and an event argument.

Except for the latest event of any attribute, the determination unit 402 sets, as the first threshold, a statistical value of processing times corresponding to the difference between the start time point and the end time point of the past event of the any attribute. Examples of the statistical value include a maximum value, a minimum value, a mean value, a mode value, a median value, or the like. Accordingly, the determination unit 402 may set the criterion for determining the unusual event processing time. By performing the statistical processing, the determination unit 402 may accurately calculate and set the criterion for determining the unusual event processing time.

The determination unit 402 sets the second threshold based on a processing time corresponding to the difference between the start time point and the end time point of a past event whose end time point is stored in the storage unit 400. For example, the determination unit 402 sets, for each attribute of an event, the second threshold based on the processing time corresponding to the difference between the start time point and the end time point of the past event of the attribute other than the latest event of the attribute. The attribute is, for example, an event name. For example, the attribute may be a combination of the event name and an event argument.

Except for the latest event of any attribute, the determination unit 402 sets, as the second threshold value, a statistical value of processing times corresponding to the difference between the start time point and the end time point of the past event of the any attribute. Examples of the statistical value include a maximum value, a minimum value, a mean value, a mode value, a median value, or the like. Accordingly, the determination unit 402 may set the criterion for determining the unusual event processing time. By performing the statistical processing, the determination unit 402 may accurately calculate and set the criterion for determining the unusual event processing time.

The determination unit 402 selects middleware. Hereinafter, the selected middleware is referred to as “target middleware” in some cases. For example, the determination unit 402 selects the middleware specified by the determination request as the target middleware. For example, the determination unit 402 may select each of the plurality of pieces of middleware being executed as the target middleware.

By reference to the storage unit 400, the determination unit 402 detects any event in which the processing time is unusual among events each processed by any process forming the target middleware. Hereinafter, the detected event is referred to as a “target event” in some cases. A process that has processed the detected event may be referred to as a “target process”.

For example, the determination unit 402 detects any event processed by any process forming the target middleware, for which the time elapsed from the start time point stored in the storage unit 400 is equal to or greater than the first threshold and the end time point is not stored in the storage unit 400. Accordingly, the determination unit 402 may obtain a criterion for identifying the type of data to be collected. For example, the determination unit 402 may recognize that there is relatively high probability that an anything unusual such as an unusual end, a stop, an operation delay, a loop, or the like has occurred in the target process, and the identification unit 403 may identify what kind of unusual situation has occurred.

For example, the determination unit 402 detects, by reference to the storage unit 400, any event processed by any process forming the target middleware, when the processing time corresponding to the difference between the start time point and the end time point is equal to or greater than the second threshold. Accordingly, the determination unit 402 may obtain a criterion for identifying the type of data to be collected. For example, the determination unit 402 may recognize that the probability that the operation delay has occurred in the target process is relatively high, and the identification unit 403 may identify whether or not the operation delay has occurred.

In a case where the target event is detected, the identification unit 403 identifies a type of data related to the target process, corresponding to the cause of the unusual processing time of the target event based on the state of the target process. The cause is an operation delay, a stop, an unusual end, a loop, or the like of the process. The type of data to be identified indicates, for example, a type of data to be collected for investigating the cause of a fault in the target middleware. The type of data to be identified is, for example, a dump file, trace information, or the like.

For example, in a case where a target event in which the end time point is not stored is detected, the identification unit 403 determines whether or not information indicating the state of the target process may be acquired. For example, when it is not possible to acquire the information, the identification unit 403 identifies the dump file of the target process corresponding to the cause of the unusual processing time=the unusual end as the type of data to be collected. Accordingly, the identification unit 403 may collect data that is preferably collected in order to investigate the cause of the fault in the target middleware.

For example, in a case where a target event in which the end time point is not stored is detected, the identification unit 403 determines whether or not the acquired information indicating the state of the target process indicates the stop. For example, when the acquired information indicating the state of the target process indicates the stop, the identification unit 403 identifies the dump file of the target process, corresponding to the cause of the unusual processing time=the stop as the type of data to be collected. Accordingly, the identification unit 403 may collect data that is preferably collected in order to investigate the cause of the fault in the target middleware.

For example, when the acquired information indicating the state of the target process does not indicate the stop, the identification unit 403 identifies the trace information of the target process, corresponding to the cause of the unusual processing time=the operation delay or the loop, as the type of data to be collected. Accordingly, the identification unit 403 may collect data that is preferably collected in order to investigate the cause of the fault in the target middleware.

For example, in a case where the target event in which the processing time is equal to or greater than the second threshold is detected, the identification unit 403 identifies the trace information of the target process, corresponding to the cause of the unusual processing time=the operation delay as the type of data to be collected. Accordingly, the identification unit 403 may collect data that is preferably collected in order to investigate the cause of the fault in the target middleware.

The output unit 404 outputs a processing result of at least any of the functional units. For example, the output form is display on a display, print output to a printer, transmission to an external apparatus through the network I/F 303, or storage in a storage area such as the memory 302 or the recording medium 305. Thus, the output unit 404 enables the user to be notified of the processing result of at least any of the functional units, thereby improving the convenience of the information processing apparatus 100.

The output unit 404 outputs the identified type in association with the target process that has processed the detected target event. For example, the output unit 404 outputs the identified type in association with the target process that has processed the detected target event so that the user may refer to the data. Accordingly, the output unit 404 enables the user to grasp the type of data that is preferably collected in order to investigate the cause of the fault in the target middleware. The output unit 404 may enable the user to collect data that is preferably collected for investigating the cause of the fault in the target middleware.

The output unit 404 collects and outputs data related to the target process of the identified type from a collection source from which data related to the process forming the middleware may be collected. For example, the output unit 404 collects data related to the target process of the identified type from the collection source from which data related to the process forming the middleware may be collected, and outputs the data so that the user may refer to the data. Accordingly, the output unit 404 enables the user to use data useful for investigating the cause of the fault in the target middleware.

The output unit 404 may further collect and output an operation log of the target process. For example, the output unit 404 collects an operation log of the target process and outputs the operation log so that the user may refer to the operation log. Accordingly, the output unit 404 enables the user to use data useful for investigating the cause of the fault in the target middleware.

The output unit 404 may further collect and output an operation log and a setting file of the OS on which the middleware operates. For example, the output unit 404 collects an operation log and a setting file of the OS on which the middleware operates, and outputs the operation log and the setting file so that the user may refer to the operation log and the setting file. Accordingly, the output unit 404 enables the user to use data useful for investigating the cause of the fault in the target middleware.

Although the case where the identification unit 403 does not directly identify the cause of the unusual processing time but identifies the type of data related to the target process, corresponding to the cause of the unusual processing time in a branch processing manner has been described, the embodiment is not limited thereto. For example, the storage unit 400 may store the cause of the unusual processing time in association with the type of data related to the process that processes the event. In this case, the identification unit 403 directly identifies the cause of the unusual processing time, and by reference to the storage unit 400, identifies the type of data related to the target process.

[Functional Configuration Example of Information Processing System 200]

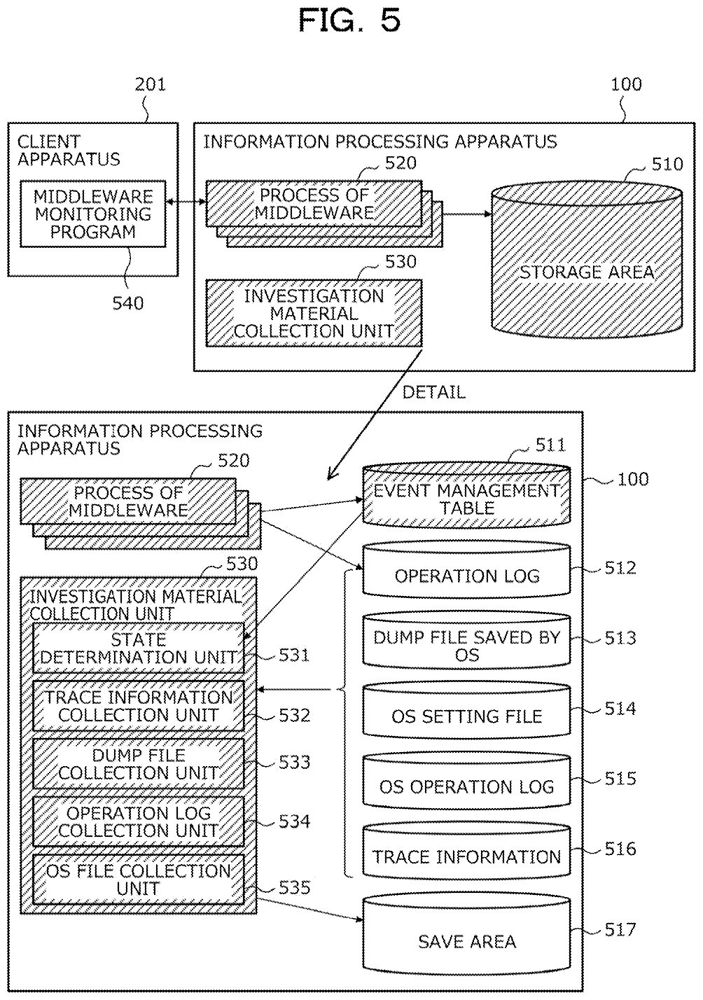

A functional configuration example of the information processing system 200 will be described with reference to FIG. 5.

FIG. 5 is a block diagram illustrating a functional configuration example of the information processing system 200. As illustrated in FIG. 5, the information processing apparatus 100 includes a storage area 510. The storage area 510 is realized by, for example, the memory 302, the recording medium 305, or the like illustrated in FIG. 3. The information processing apparatus 100 executes a process 520 of middleware. The information processing apparatus 100 includes an investigation material collection unit 530.

The client apparatus 201 executes the middleware monitoring program 540. By the middleware monitoring program 540, the client apparatus 201 monitors the state of the middleware. By the middleware monitoring program 540, the client apparatus 201 outputs the monitored state of the middleware so that the user may refer to the state of the middleware. By reference to the state of the middleware, the user determines whether or not a fault has occurred in the middleware. Based on an operation input by the user who has determined that a fault has occurred in the middleware, the client apparatus 201 transmits a determination request to the information processing apparatus 100. The determination request includes specification of the middleware.

Upon receiving the determination request, the investigation material collection unit 530 of the information processing apparatus 100 collects the investigation material related to the specified middleware from the storage area 510 and transmits the investigation material to the client apparatus 201. The client apparatus 201 receives the investigation material related to the specified middleware. The client apparatus 201 outputs the received investigation material so that the user may refer to the investigation material.

For example, the storage area 510 includes an event management table 511, an operation log 512, a dump file 513, an OS setting file 514, an OS operation log 515, trace information 516, and a save area 517. The event management table 511 stores a record in which an event name of an event, an event argument of the event, a start time point of the event, and an end time point of the event are associated with each other.

At the time of starting the processing of an event, the process 520 generates a record related to the event in which the event name of the event, the event argument of the event, and the start time point of the event are associated with each other, the end time point of the event being empty. The process 520 stores the generated record in the event management table 511. At the time of ending the processing of an event, the process 520 searches the event management table 511 for a record related to the event including a combination of the event name of the event and the event argument of the event. The process 520 adds the end time point of the event to the retrieved record.

The investigation material collection unit 530 includes a state determination unit 531, a trace information collection unit 532, a dump file collection unit 533, an operation log collection unit 534, and an OS file collection unit 535. The state determination unit 531 determines the state of the process 520. The state of the process 520 indicates the cause of the unusual processing time of the event processed by the process 520. Based on the state of the process 520, the state determination unit 531 identifies the type of investigation material to be collected. Based on the identified result, the state determination unit 531 controls the trace information collection unit 532, the dump file collection unit 533, the operation log collection unit 534, and the OS file collection unit 535 to collect the investigation material.

According to the control of the state determination unit 531, the trace information collection unit 532 collects trace information of the process 520 and saves the trace information in the save area 517 in association with the process 520. According to the control of the state determination unit 531, the dump file collection unit 533 collects the dump file 513 of the process 520 and saves the dump file 513 in the save area 517 in association with the process 520.

According to the control of the state determination unit 531, the operation log collection unit 534 collects the operation log 512 of the process 520 and saves the operation log 512 in the save area 517 in association with the process 520. According to the control of the state determination unit 531, the OS file collection unit 535 collects the OS setting file 514 and the OS operation log 515, and saves them in the save area 517 in association with the process 520. Accordingly, the information processing apparatus 100 may reduce a processing load to be imposed when the cause of the fault in the middleware is identified. For example, the information processing apparatus 100 may collect the appropriate investigation material that makes it possible to identify the cause of the fault in the middleware, and may enable the user to refer to the investigation material.

[Operation Example of Information Processing Apparatus 100]

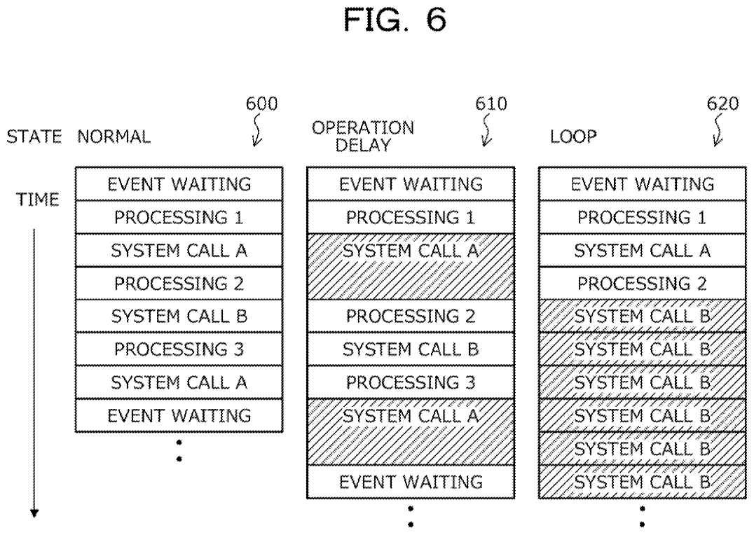

Next, an operation example of the information processing apparatus 100 will be described with reference to FIGS. 6 to 9.

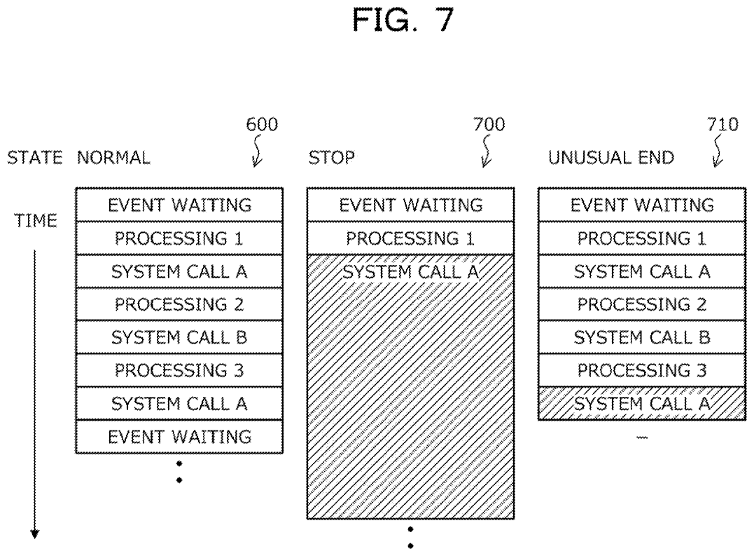

FIGS. 6 to 9 are explanatory diagrams illustrating the operation example of the information processing apparatus 100. First, an example of features appearing in an operation of a process in a case where the process is unusual will be described with reference to FIGS. 6 and 7. Examples of anything unusual include an operation delay, a loop, a stop, an unusual end, or the like.

FIG. 6 illustrates a time series 600 of the operation of the process in a case where the process is normal. As illustrated in the time series 600, the process waits until the event occurs, in an event waiting state. In a case where the process is normal, the process is configured to, in response to the occurrence of the event, normally execute a processing 1, a system call A, a processing 2, a system call B, a processing 3, and the system call A in this order without delay, and return to the event waiting state.

FIG. 6 illustrates a time series 610 of the operation of the process in a case where the process is unusual=the operation delay. As illustrated in the time series 610, the operation delay may occur in the system call A, and a time taken for the process to execute the system call A may increase as compared with the case where the process is normal. By contrast, it is conceivable that the presence of the trace information 516 of the process makes it possible to identify that the operation delay of the system call A has occurred. Accordingly, in the case where the process is unusual=the operation delay, it is considered preferable to collect the trace information 516 of the process.

FIG. 6 illustrates a time series 620 of the operation of the process in a case where the process is unusual=the loop. As illustrated in the time series 620, a loop occurs in the system call B, and the process does not end the processing. By contrast, it is conceivable that the presence of the trace information 516 of the process makes it possible to identify that the loop of the system call B has occurred. Accordingly, in the case where the process is unusual=the loop, it is considered preferable to collect the trace information 516 of the process. Next, the description continues with reference to FIG. 7.

FIG. 7 illustrates a time series 700 of the operation of the process in a case where the process is unusual=the stop. As illustrated in the time series 700, there is a case where the process is stopped at the time of the system call A and the process does not end the processing. By contrast, it is conceivable that the presence of the dump file 513 of the process make it possible to identify that the process has been stopped at the time of the system call A. Accordingly, in a case where the process is unusual=the stop, it is considered preferable to collect the dump file 513 of the process.

FIG. 7 illustrates a time series 710 of the operation of the process in a case where the process is unusual=the unusual end. As illustrated in the time series 710, there is a case where the process unusually ends at the time of the system call A and the process ends the processing. By contrast, it is conceivable that the presence of the dump file 513 of the process makes it possible to identify that the process unusually ends at the time of the system call A. Accordingly, in the case where the process is unusual=the unusual end, it is considered preferable to collect the dump file 513 of the process.

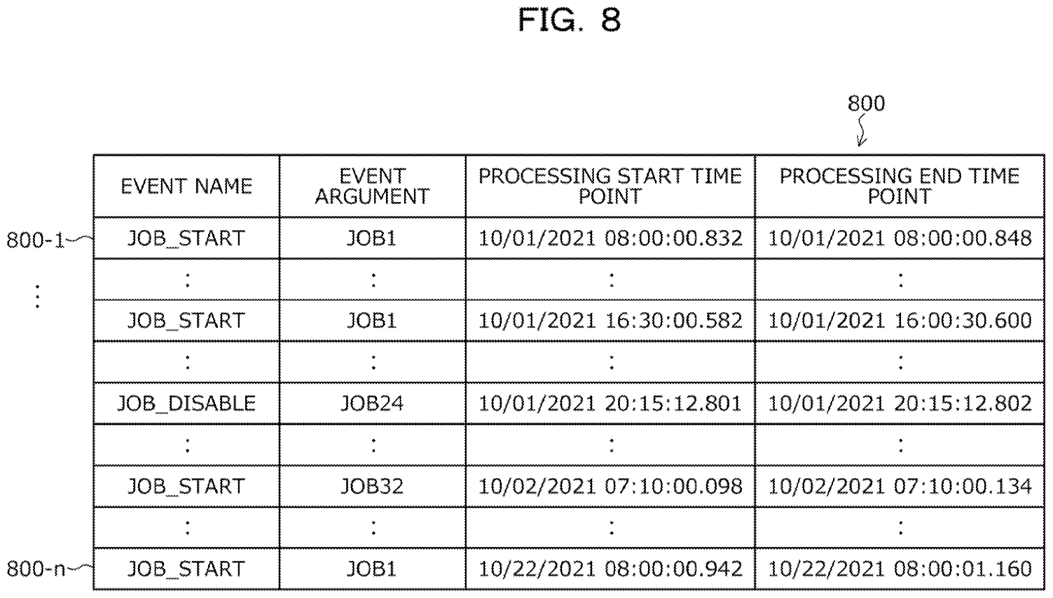

As described above, depending on the unusual type that has occurred in the process, the types of investigation materials that are useful when investigating the cause of a fault in the middleware including the process vary. Examples of the investigation material include the trace information 516, the dump file 513, or the like. Accordingly, it is desirable that the information processing apparatus 100 identify the type of the investigation material useful for investigating the cause of the fault in the middleware including the process, in accordance with the unusual type that has occurred in the process. Next, the description continues with reference to FIG. 8.

A case where the information processing apparatus 100 stores the event management table 511=an event management table 800 in FIG. 8 will be described. The event management table 800 is realized by the storage area such as the memory 302 or the recording medium 305 of the information processing apparatus 100 illustrated in FIG. 3, for example. The event management table 800 has fields of an event name, an event argument, a processing start time point, and a processing end time point. A record 800-a representing event management information is stored in the event management table 800 by setting information in each field for each event. Here, “a” is an arbitrary integer. In the example illustrated in FIG. 8, “a” is an arbitrary integer from 1 to n.

The event name of the event processed by the process forming the middleware is set in the event name field. The event argument of the above event is set in the field of the event argument. The processing start time point at which the above process has started processing the above event is set in the field of the processing start time point. The processing end time point at which the above process ends processing the above event is set in the field of the processing end time point.

The information processing apparatus 100 reads a latest record 800-n in the event management table 800. From the event management table 800, the information processing apparatus 100 reads the past record 800-a whose event name and event argument match those of the latest record 800-n. The information processing apparatus 100 calculates the processing time corresponding to the difference between the processing start time point and the processing end time point in the read past record 800-a, and calculates a statistical value of the processing time. Examples of the statistical value include a maximum value, a minimum value, a mean value, a median value, a mode value, or the like. The information processing apparatus 100 sets the statistical value of the calculated processing time as a threshold.

The information processing apparatus 100 determines whether or not a pair of the processing start time point and the processing end time point is stored in the latest record 800-n. When the pair of the processing start time point and the processing end time point is stored, the information processing apparatus 100 calculates the processing time corresponding to a difference between the processing start time point and the processing end time point, and determines whether or not the processing time exceeds the set threshold. In a case where the calculated processing time does not exceed the set threshold, the information processing apparatus 100 identifies that the process is normal. For this reason, the information processing apparatus 100 may not collect the investigation material. Alternatively, the information processing apparatus 100 may output a notification indicating that the process is normal so that the user may refer to the notification.

By contrast, when the calculated processing time exceeds the set threshold, the information processing apparatus 100 determines that the situation is similar to the situation in the time series 610 described above, and identifies that the process is unusual as the unusual process=the operation delay. Due to the unusual process=the operation delay, the information processing apparatus 100 identifies the trace information 516 of the process as the investigation material to be collected. The information processing apparatus 100 collects the trace information 516 of the process. The information processing apparatus 100 outputs the trace information 516 of the process so that the user may refer to the trace information 516.

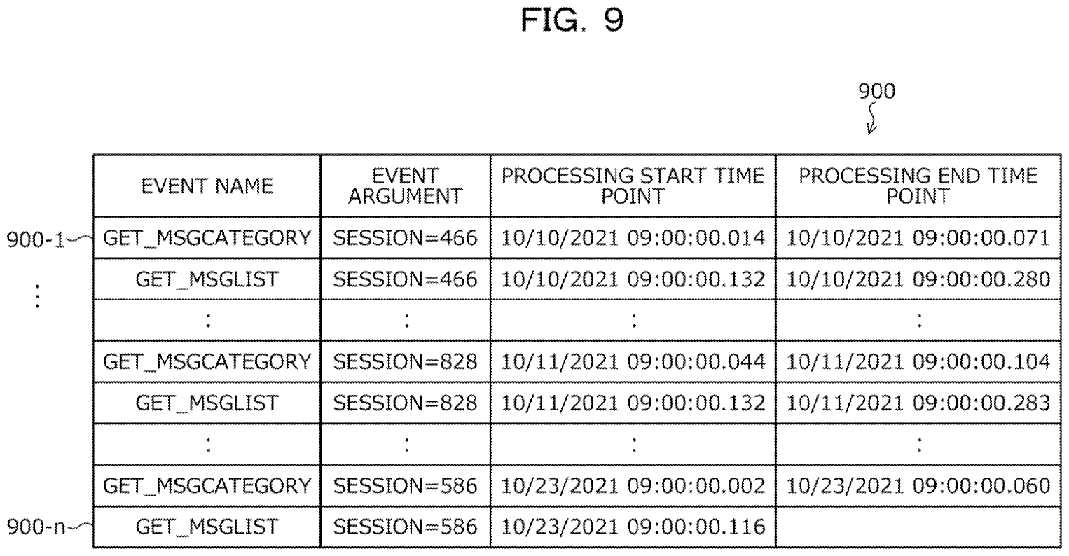

Accordingly, the information processing apparatus 100 may select the investigation material useful for investigating the cause of the fault in the middleware including the process, depending on the unusual type that has occurred in the process. The information processing apparatus 100 may make it easy for the user to investigate the cause of the fault in the middleware including the process. Next, the description continues with reference to FIG. 9.

A case where the information processing apparatus 100 stores the event management table 511=an event management table 900 in FIG. 9 will be described. The event management table 900 is realized by a storage area such as the memory 302 or the recording medium 305 of the information processing apparatus 100 illustrated in FIG. 3, for example. The event management table 900 has fields of an event name, an event argument, a processing start time point, and a processing end time point. A record 900-b representing event management information is stored in the event management table 900 by setting information in each field for each event. Here, “b” is an arbitrary integer. In the example illustrated in FIG. 9, “b” is an arbitrary integer from 1 to n.

The event name of the event processed by the process forming the middleware is set in the event name field. The event argument of the above event is set in the field of the event argument. The processing start time point at which the above process has started processing the above event is set in the field of the processing start time point. The processing end time point at which the above process ends processing the above event is set in the field of the processing end time point.

The information processing apparatus 100 reads the latest record 900-n in the event management table 900. From the event management table 900, the information processing apparatus 100 reads the past record 900-b whose event name and event argument match those of the latest record 900-n. Alternatively, in a case where the number of past records 900-b whose event names and event arguments match those of the latest record 900-n is relatively small, the information processing apparatus 100 may read the past record 900-b whose event name matches that of the latest record 900-n.

For example, a process that monitors a log, a process, or the like of a system may process a plurality of events having the same event name but having different event arguments in accordance with date and time, a process ID, and the like. Even when the event arguments are different, the processing contents of the plurality of events are the same. For this reason, in some cases, it is preferable that the information processing apparatus 100 read the past record 900-b whose event name matches the event name of the latest record 900-n.

The information processing apparatus 100 calculates the processing time corresponding to the difference between the processing start time point and the processing end time point in the read past record 900-b, and calculates a statistical value of the processing time. Examples of the statistical value include a maximum value, a minimum value, a mean value, a median value, a mode value, or the like. The information processing apparatus 100 sets the statistical value of the calculated processing time as a threshold.

The information processing apparatus 100 determines whether or not a pair of the processing start time point and the processing end time point is stored in the latest record 900-n. When the processing end time point is empty, the information processing apparatus 100 calculates an elapsed time corresponding to a difference between the processing start time point and the current time point, and determines whether or not the calculated elapsed time exceeds the set threshold. In a case where the calculated elapsed time does not exceed the set threshold, the information processing apparatus 100 determines that there is room for the process to normally end the processing, waits for a certain period of time, and then calculates the elapsed time again to compare the elapsed time with the threshold.

By contrast, in a case where the calculated elapsed time exceeds the set threshold, the information processing apparatus 100 determines that the process is unusual as the unusual process=any one of the loop, the stop, and the unusual end. Among the pieces of information indicating the states of the processes managed by the OS, the information processing apparatus 100 searches for information indicating the state of the process that is determined as unusual.

In a case where the information indicating the state of the process is not found, the information processing apparatus 100 determines that the situation is similar to the situation in the time series 710 described above, and identifies the unusual process=the unusual end. Due to the unusual process=the unusual end, the information processing apparatus 100 identifies the dump file 513 of the process saved by the OS as the investigation material to be collected. The information processing apparatus 100 collects the dump file 513 of the process. The information processing apparatus 100 outputs the dump file 513 of the process so that the user may refer to the dump file 513.

Accordingly, the information processing apparatus 100 may select the investigation material useful for investigating the cause of the fault in the middleware including the process, depending on the unusual type that has occurred in the process. The information processing apparatus 100 may make it easy for the user to investigate the cause of the fault in the middleware including the process.

In a case where the information indicating the state of the process is found, when the information indicating the state of the process indicates the stop, the information processing apparatus 100 determines that the situation is similar to the situation in the time series 700 described above, and identifies the unusual process=the stop. Due to the unusual process=the stop, the information processing apparatus 100 identifies the dump file 513 of the process saved by the OS as the investigation material to be collected. The information processing apparatus 100 collects the dump file 513 of the process. The information processing apparatus 100 outputs the dump file 513 of the process so that the user may refer to the dump file 513.

Accordingly, the information processing apparatus 100 may select the investigation material useful for investigating the cause of the fault in the middleware including the process, depending on the unusual type that has occurred in the process. The information processing apparatus 100 may make it easy for the user to investigate the cause of the fault in the middleware including the process.

In a case where the information indicating the state of the process is found, when the information indicating the state of the process does not indicate the stop, the information processing apparatus 100 determines that the situation is similar to the situation in the time series 610 or the time series 620 described above, and identifies the unusual process=the operation delay or the loop. Due to the unusual process=the operation delay or the loop, the information processing apparatus 100 identifies the trace information 516 of the process saved by the OS as the investigation material to be collected. The information processing apparatus 100 collects the trace information 516 of the process. The information processing apparatus 100 outputs the trace information 516 of the process so that the user may refer to the trace information 516.

Accordingly, the information processing apparatus 100 may select the investigation material useful for investigating the cause of the fault in the middleware including the process, depending on the unusual type that has occurred in the process. The information processing apparatus 100 may make it easy for the user to investigate the cause of the fault in the middleware including the process.

As described above, in a case where a fault occurs in the middleware due to the environment in which the middleware is executed, the information processing apparatus 100 may collect the appropriate investigation material suitable for the cause of the fault and suppress an increase in the number of investigation materials to be collected. For this reason, the information processing apparatus 100 may reduce the processing load and the processing time for the environment in which the middleware is executed. According to the information processing apparatus 100, it is possible to suppress an adverse effect on tasks of a customer or the like who uses the environment in which the middleware is executed.

According to the information processing apparatus 100, it is possible to reduce the work load and the work time on the person in charge of the operation, the person in charge of the investigation, and the like who investigate the cause of the fault in the middleware. According to the information processing apparatus 100, it is possible to reduce the time taken to identify the cause of the fault in the middleware, and thus to easily solve the fault at an early stage.

[Event Processing Procedure]

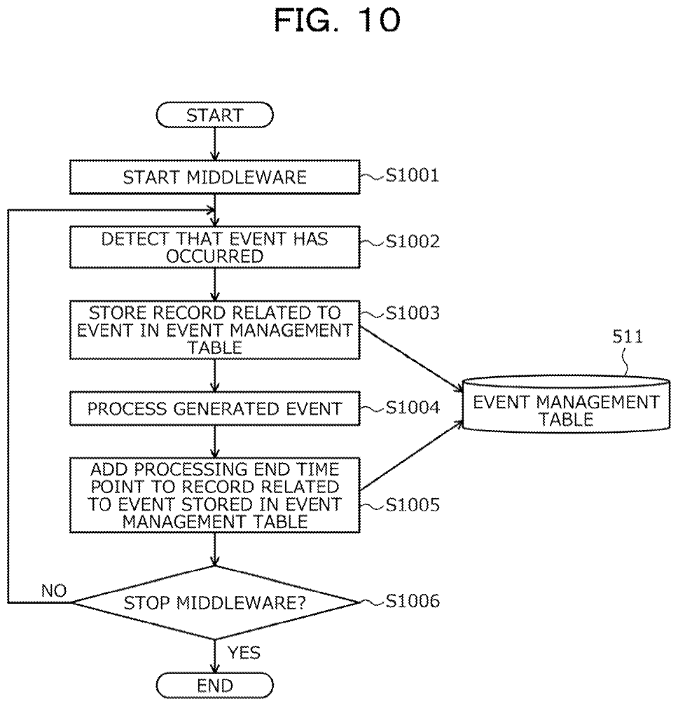

An example of an event processing procedure executed by the information processing apparatus 100 will be described next with reference to FIG. 10. The event processing is realized by, for example, the CPU 301 illustrated in FIG. 3, the storage area such as the memory 302 or the recording medium 305, and the network I/F 303.

FIG. 10 is a flowchart illustrating an example of the event processing procedure. The information processing apparatus 100 starts the middleware (operation S1001).

After that, the information processing apparatus 100 detects that an event corresponding to the process of the started middleware has occurred (operation S1002). When detecting that an event has occurred, the information processing apparatus 100 stores, in the event management table 511, a record related to the event in which an event name, an event argument, a processing start time point, and a processing end time point=the empty are associated with each other (operation S1003).

Next, the information processing apparatus 100 processes the generated event by the process (operation S1004). When the processing of the generated event is ended by the process, the information processing apparatus 100 adds the processing end time point to the record related to the event stored in the event management table 511 (operation S1005).

Next, the information processing apparatus 100 determines whether or not to stop the middleware (operation S1006). In a case where the middleware is not stopped (operation S1006: No), the information processing apparatus 100 returns to the processing in operation S1002. By contrast, in a case where the middleware is stopped (operation S1006: Yes), the information processing apparatus 100 ends the event processing.

[Collection Control Processing Procedure]

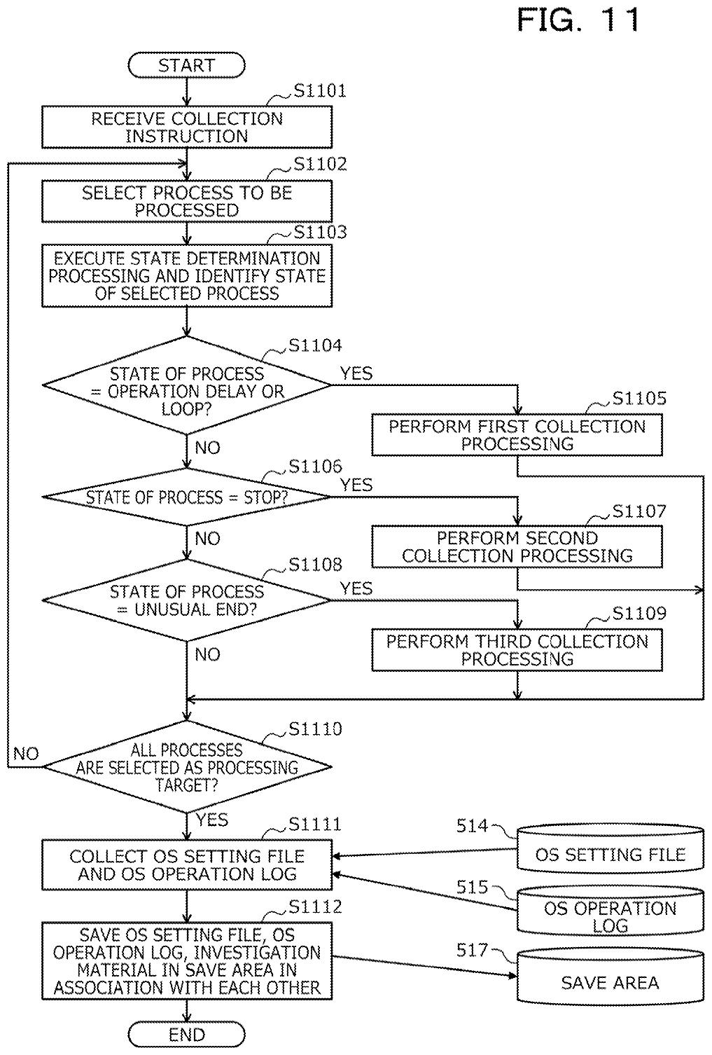

Next, an example of a collection control processing procedure executed by the information processing apparatus 100 will be described with reference to FIG. 11. The collection control processing is realized by, for example, the CPU 301 illustrated in FIG. 3, the storage area such as the memory 302 or the recording medium 305, and the network I/F 303.

FIG. 11 is a flowchart illustrating an example of the collection control processing procedure. As illustrated in FIG. 11, the information processing apparatus 100 receives a collection instruction (operation S1101).

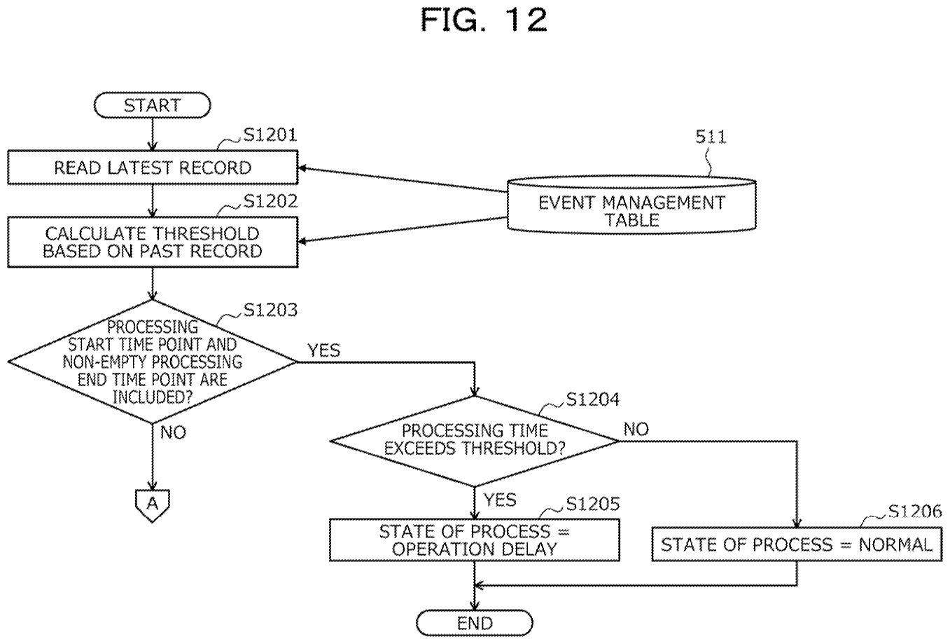

Next, the information processing apparatus 100 selects a process to be processed (operation S1102). As for the selected process, the information processing apparatus 100 executes state determination processing, which will be described later with reference to FIG. 12, and identifies the state of the selected process (operation S1103).

Next, the information processing apparatus 100 determines whether or not the state of the selected process is the operation delay or the loop (operation S1104). In a case where the state is neither the operation delay nor the loop (operation S1104: No), the information processing apparatus 100 proceeds to processing in operation S1106. By contrast, in a case of the operation delay or the loop (operation S1104: Yes), the information processing apparatus 100 proceeds to the processing in operation S1105.

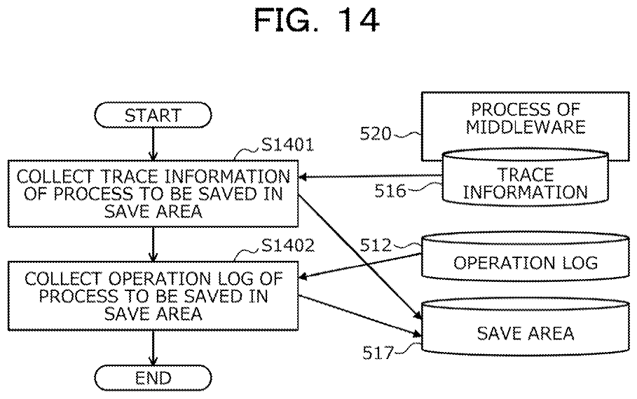

At operation S1105, the information processing apparatus 100 executes first collection processing to be described later in FIG. 14 to collect the investigation material (operation S1105). The information processing apparatus 100 proceeds to the processing in operation S1110.

At operation S1106, the information processing apparatus 100 determines whether or not the state of the selected process is the stop (operation S1106). In a case where the state is not the stop (operation S1106: No), the information processing apparatus 100 proceeds to the processing in operation S1108. By contrast, in a case of the stop (operation S1106: Yes), the information processing apparatus 100 proceeds to the processing in operation S1107.

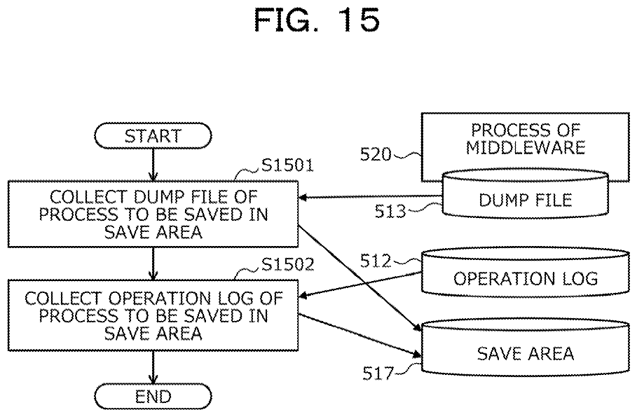

At operation S1107, the information processing apparatus 100 executes second collection processing to be described later in FIG. 15 to collect the investigation material (operation S1107). The information processing apparatus 100 proceeds to the processing in operation S1110.

At operation S1108, the information processing apparatus 100 determines whether or not the state of the selected process is the unusual end (operation S1108). In a case where the state is not the unusual end (operation S1108: No), the information processing apparatus 100 proceeds to the processing in operation S1110. By contrast, in the case of the unusual end (operation S1108: Yes), the information processing apparatus 100 proceeds to the processing in operation S1109.

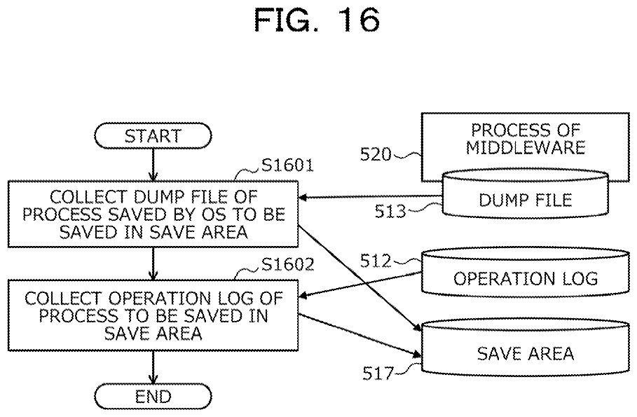

At operation S1109, the information processing apparatus 100 executes third collection processing to be described later in FIG. 16 to collect the investigation material (operation S1109). The information processing apparatus 100 proceeds to the processing in operation S1110.

At operation S1110, the information processing apparatus 100 determines whether or not all the processes have been selected as processing targets (operation S1110). In a case where there is a process that has not been selected yet (operation S1110: No), the information processing apparatus 100 returns to the processing in operation S1102. By contrast, in a case where all the processes are selected as the processing targets (operation S1110: Yes), the information processing apparatus 100 proceeds to the processing in operation S1111.

At operation S1111, the information processing apparatus 100 collects the OS setting file 514 and the OS operation log 515 (operation S1111). Next, the information processing apparatus 100 saves the OS setting file 514, the OS operation log 515, and the collected investigation material in the save area 517 in association with each other (operation S1112). The information processing apparatus 100 ends the collection control processing.

[State Determination Processing Procedure]

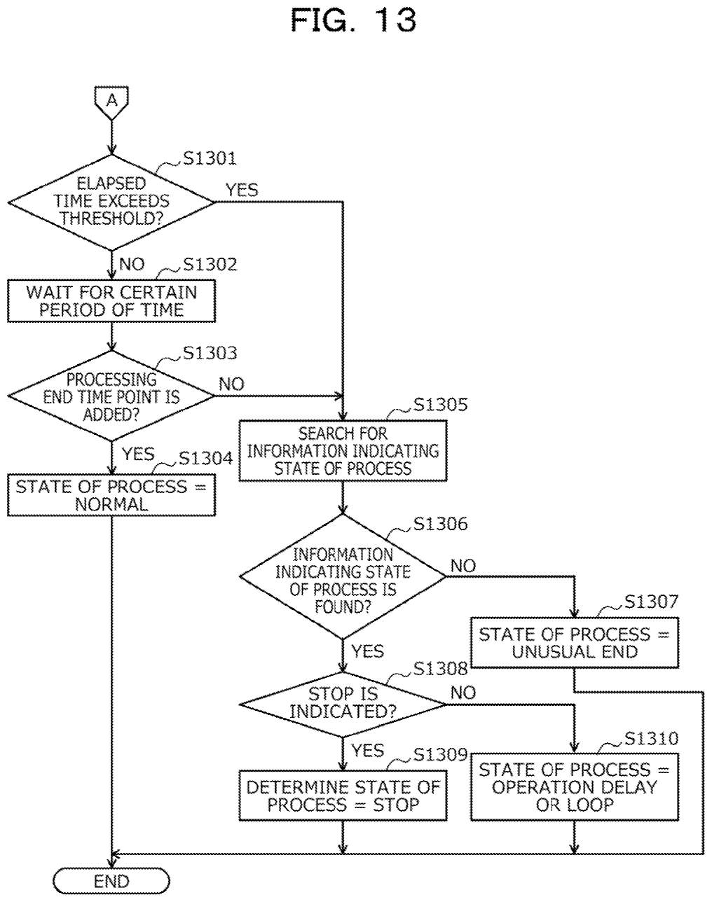

Next, an example of a state determination processing procedure executed by the information processing apparatus 100 will be described below with reference to FIGS. 12 and 13. The state determination processing is, for example, realized by the CPU 301, the storage area such as the memory 302 or the recording medium 305, and the network I/F 303 illustrated in FIG. 3.

FIGS. 12 and 13 are flowcharts illustrating an example of the state determination processing procedure. As illustrated in FIG. 12, the information processing apparatus 100 reads the latest record among the records related to the selected process stored in the event management table 511 (operation S1201).

Based on the past record whose event name and event argument match those of the read latest record, the information processing apparatus 100 calculates the threshold (operation S1202). The information processing apparatus 100 determines whether or not the latest record includes the processing start time point and a non-empty processing end time point (operation S1203).

In a case where the processing start time point and the non-empty processing end time point are not included in the latest record (operation S1203: No), the information processing apparatus 100 proceeds to the processing in operation S1301 in FIG. 13. By contrast, in a case where the processing start time point and the non-empty processing end time point are included in the latest record (operation S1203: Yes), the information processing apparatus 100 proceeds to the processing in operation S1204.

At operation S1204, the information processing apparatus 100 determines whether or not the processing time corresponding to the elapsed time from the processing start time point to the processing end time point exceeds the calculated threshold (operation S1204). In a case where the processing time exceeds the threshold (operation S1204: Yes), the information processing apparatus 100 proceeds to the processing in operation S1205. By contrast, in a case where the processing time does not exceed the calculated threshold (operation S1204: No), the information processing apparatus 100 proceeds to the processing in operation S1206.

At operation S1205, the information processing apparatus 100 determines the state of the selected process=the operation delay (operation S1205). The information processing apparatus 100 ends the state determination processing.

At operation S1206, the information processing apparatus 100 determines the state of the selected process=the normal (operation S1206). The information processing apparatus 100 ends the state determination processing. Next, the description continues with reference to FIG. 13.

As illustrated in FIG. 13, the information processing apparatus 100 determines whether or not the elapsed time from the processing start time point of the latest record to the current time point exceeds the threshold (operation S1301). In a case where the elapsed time exceeds the threshold (operation S1301: Yes), the information processing apparatus 100 proceeds to the processing in operation S1305. By contrast, in a case where the elapsed time does not exceed the threshold (operation S1301: No), the information processing apparatus 100 proceeds to the processing in operation S1302.

At operation S1302, the information processing apparatus 100 waits for a certain period of time (operation S1302). For example, the certain period of time is the time shorter than the threshold. For example, the certain period of time is the time equal to or shorter than the difference between the threshold and the elapsed time.

Next, the information processing apparatus 100 determines whether or not the processing end time point of the latest record is added (operation S1303). In a case where the processing end time point of the latest record is added (operation S1303: Yes), the information processing apparatus 100 proceeds to the processing in operation S1304. By contrast, in a case where the processing end time point of the latest record is not added (operation S1303: No), the information processing apparatus 100 proceeds to the processing in operation S1305.

At operation S1304, the information processing apparatus 100 determines the state of the selected process=the normal (operation S1304). The information processing apparatus 100 ends the state determination processing.

At operation S1305, the information processing apparatus 100 searches for information indicating the state of the process managed by the OS (operation S1305). Next, the information processing apparatus 100 determines whether or not the information indicating the state of the process managed by the OS is found (operation S1306). In a case where the information is not found (operation S1306: No), the information processing apparatus 100 proceeds to the processing in operation S1307. By contrast, in a case where the information is found (operation S1306: Yes), the information processing apparatus 100 proceeds to the processing in operation S1308.

At operation S1307, the information processing apparatus 100 determines the state of the selected process=the unusual end (operation S1307). The information processing apparatus 100 ends the state determination processing.

At operation S1308, the information processing apparatus 100 determines whether or not the information indicating the state of the process indicates the stop (operation S1308). In a case where the information indicates the stop (operation S1308: Yes), the information processing apparatus 100 proceeds to the processing in operation S1309. By contrast, in a case where the information does not indicate the stop (operation S1308: No), the information processing apparatus 100 proceeds to the processing in operation S1310.

At operation S1309, the information processing apparatus 100 determines the state of the selected process=the stop (operation S1309). The information processing apparatus 100 ends the state determination processing.

At operation S1310, the information processing apparatus 100 determines the state of the selected process=the operation delay or the loop (operation S1310). The information processing apparatus 100 ends the state determination processing.

[First Collection Processing Procedure]

Next, an example of a first collection processing procedure executed by the information processing apparatus 100 will be described with reference to FIG. 14. For example, the first collection processing is realized by the CPU 301 illustrated in FIG. 3, the storage area such as the memory 302 or the recording medium 305, and the network I/F 303.

FIG. 14 is a flowchart illustrating an example of the first collection processing procedure. As illustrated in FIG. 14, the information processing apparatus 100 collects the trace information 516 of the process and saves the trace information 516 in the save area 517 (operation S1401). Next, the information processing apparatus 100 collects the operation log 512 of the process and saves the operation log 512 in the save area 517 (operation S1402). The information processing apparatus 100 ends the first collection processing.

[Second Collection Processing Procedure]

Next, an example of a second collection processing procedure executed by the information processing apparatus 100 will be described with reference to FIG. 15. For example, the second collection processing is realized by the CPU 301 illustrated in FIG. 3, the storage area such as the memory 302 or the recording medium 305, and the network I/F 303.

FIG. 15 is a flowchart illustrating an example of the second collection processing procedure. As illustrated in FIG. 15, the information processing apparatus 100 collects the dump file 513 of the process and saves the dump file 513 in the save area 517 (operation S1501). Next, the information processing apparatus 100 collects the operation log 512 of the process and saves the operation log 512 in the save area 517 (operation S1502). The information processing apparatus 100 ends the second collection processing.

[Third Collection Processing Procedure]

Next, an example of a third collection processing procedure executed by the information processing apparatus 100 will be described with reference to FIG. 16. For example, the third collection processing is realized by the CPU 301 illustrated in FIG. 3, the storage area such as the memory 302 or the recording medium 305, and the network I/F 303.

FIG. 16 is a flowchart illustrating an example of the third collection processing procedure. As illustrated in FIG. 16, the information processing apparatus 100 collects the dump file 513 of the process saved by the OS, and saves the dump file 513 in the save area 517 (operation S1601). Next, the information processing apparatus 100 collects the operation log 512 of the process and saves the operation log 512 in the save area 517 (operation S1602). The information processing apparatus 100 ends the third collection processing.

The information processing apparatus 100 may execute the processing with the order of some operations reversed in each of the flowcharts illustrated in FIGS. 10 to 16. The information processing apparatus 100 may skip the processing in some operations in each of the flowcharts illustrated in FIGS. 10 to 16.

As described above, according to the information processing apparatus 100, it is possible to have the storage unit in which the start time point and the end time point of the event processed by the process forming the middleware in which the fault has occurred are stored. According to the information processing apparatus 100, by reference to the storage unit, it is possible to detect any event processed by any process forming the middleware, when the processing time is unusual. According to the information processing apparatus 100, in a case where any event is detected, it is possible to identify the type of data related to any process corresponding to the cause of the unusual processing time of the detected any event, based on the state of the any process. Accordingly, the information processing apparatus 100 may make it possible to collect data useful for investigating the cause of the fault in the middleware. The information processing apparatus 100 may reduce the work load and the work time on the user. According to the information processing apparatus 100, it is possible to reduce the processing load and the processing time for the environment in which the middleware is executed.

According to the information processing apparatus 100, it is possible to collect and output data, of the identified type, related to the any process from a collection source from which data related to the process forming the middleware may be collected. Accordingly, the information processing apparatus 100 may enable the user to use data useful for investigating the cause of the fault in the middleware.

According to the information processing apparatus 100, it is possible to detect a first event processed by a first process forming the middleware, when the time elapsed from the start time point stored in the storage unit is equal to or greater than the first threshold and the end time point is not stored in the storage unit. According to the information processing apparatus 100, in a case where the first event is detected, when the information indicating the state of the first process may not be acquired, it is possible to identify the dump file of the first process as the type. Accordingly, in the case of the unusual process=the unusual end, the information processing apparatus 100 may collect data useful for investigating the cause of the fault in the middleware.

According to the information processing apparatus 100, it is possible to detect a second event processed by a second process forming the middleware, when the time elapsed from the start time point stored in the storage unit is equal to or greater than the first threshold and the end time point is not stored in the storage unit. According to the information processing apparatus 100, in a case where the second event is detected, when the acquired information indicating the state of the second process indicates the stop, it is possible to identify the dump file of the second process as the type. Accordingly, in a case of the unusual process=the stop, the information processing apparatus 100 may collect data useful for investigating the cause of the fault in the middleware.

According to the information processing apparatus 100, it is possible to detect a third event processed by a third process forming the middleware, when the time elapsed from the start time point stored in the storage unit is equal to or greater than the first threshold and the end time point is not stored in the storage unit. According to the information processing apparatus 100, in a case where the third event is detected, when the acquired information indicating the state of the third process does not indicate the stop, it is possible to identify the trace information of the third process as the type. Accordingly, in a case where the unusual process=the operation delay or the loop, the information processing apparatus 100 may collect data useful for investigating the cause of the fault in the middleware.

According to the information processing apparatus 100, it is possible to detect, by reference to the storage unit, a fourth event processed by a fourth process forming the middleware, when the processing time corresponding to the difference between the start time point and the end time point is equal to or greater than the second threshold. According to the information processing apparatus 100, in a case where the fourth event is detected, it is possible to identify the trace information of the fourth process as the type. Accordingly, in a case where the unusual process=the operation delay, the information processing apparatus 100 may collect data useful for investigating the cause of the fault in the middleware.

According to the information processing apparatus 100, it is possible to set the first threshold based on the processing time corresponding to the difference between the start time point and the end time point of the past event in which the end time point is stored in the storage unit. Accordingly, the information processing apparatus 100 may accurately determine whether or not the processing time of the event is unusual by using the first threshold.

According to the information processing apparatus 100, it is possible to output the identified type in association with any process that has processed the detected any event. Accordingly, the information processing apparatus 100 may enable the user to grasp and collect data useful for investigating the cause of the fault in the middleware.

According to the information processing apparatus 100, it is possible to collect and output an operation log of any process. Accordingly, the information processing apparatus 100 may enable the user to use data useful for investigating the cause of the fault in the middleware.

According to the information processing apparatus 100, it is possible to collect and output the operation log and the setting file of the operating system where the middleware operates. Accordingly, the information processing apparatus 100 may enable the user to use data useful for investigating the cause of the fault in the middleware.

The information processing method described in the present embodiment may be implemented by causing a computer, such as a personal computer (PC) or a workstation, to execute a program prepared in advance. The information processing program described in the present embodiment is recorded on a computer-readable recording medium and is read from the recording medium to be executed by the computer. The recording medium is a hard disk, a flexible disk, a compact disc (CD)-ROM, a magneto-optical (MO) disc, a Digital Versatile Disc (DVD), or the like. The information processing program described in the present embodiment may be distributed via a network, such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a procedure, the procedure comprising:
acquiring a start time and an end time of an event processed by a process forming software in which a fault has occurred from a storage;
detecting any event in which a processing time is unusual, the any event being processed by any process forming the software; and
identifying, when the any event is detected, a type of data related to the any process corresponding to a cause of an unusual processing time of the detected any event, based on a state of the any process.

2. The non-transitory computer-readable recording medium according to claim 1, the procedure further comprising:
collecting the data of the identified type from a collection source from which data related to the process forming the software is able to be collected, and outputting the data.

3. The non-transitory computer-readable recording medium according to claim 1, wherein the procedure
detects a first event processed by a first process forming the software, when a time elapsed from the start time stored in the storage is equal to or greater than a first threshold and the end time is not stored in the storage, and
identifies, when the first event is detected, a dump file of the first process as the type of data, when information that indicates a state of the first process is not able to be acquired.

4. The non-transitory computer-readable recording medium according to claim 1, wherein the procedure
detects a second event processed by a second process forming the software, when a time elapsed from the start time stored in the storage is equal to or greater than a first threshold, and the end time is not stored in the storage, and
identifies, when the second event is detected, a dump file of the second process as the type of data, when information that indicates a state of the second process indicates a stop.

5. The non-transitory computer-readable recording medium according to claim 1, wherein the procedure
detects a third event processed by a third process forming the software, when a time elapsed from the start time stored in the storage is equal to or greater than a first threshold, and the end time is not stored in the storage, and
identifies, when the third event is detected, trace information of the third process as the type of data, when information that indicates a state of the third process does not indicate a stop.

6. The non-transitory computer-readable recording medium according to claim 1, wherein the procedure
detects a fourth event processed by a fourth process forming the software, when a processing time corresponding to a difference between the start time and the end time is equal to or greater than a second threshold, and
identifies, when the fourth event is detected, trace information of the fourth process as the type of data.

7. The non-transitory computer-readable recording medium according to claim 3, the procedure further comprising:
setting the first threshold based on a processing time corresponding to a difference between a past start time and a past end time of a past event in which the end time point is stored in the storage.

8. The non-transitory computer-readable recording medium according to claim 1, the procedure further comprising:
outputting the identified type of data in association with the any process that has processed the detected any event.

9. The non-transitory computer-readable recording medium according to claim 1, wherein the procedure collects an operation log of the any process and outputs the operation log.

10. The non-transitory computer-readable recording medium according to claim 1, wherein the procedure collects an operation log and a setting file of an operating system in which the software operates and outputs the operation log and the setting file.

11. An information processing method for causing a computer to execute a procedure, the procedure comprising:
acquiring a start time and an end time of an event processed by a process forming software in which a fault has occurred from a storage;
detecting any event in which a processing time is unusual, the any event being processed by any process forming the software; and
identifying, when the any event is detected, a type of data related to the any process corresponding to cause of an unusual processing time of the detected any event, based on a state of the any process.

12. An information processing apparatus comprising:
a memory; and
a processor coupled to the memory and configured to:
acquire a start time and an end time of an event processed by a process forming software in which a fault has occurred from the memory;
detect any event in which a processing time is unusual, the any event being processed by any process forming the software; and
identify, when the any event is detected, a type of data related to the any process corresponding to cause of an unusual processing time of the detected any event, based on a state of the any process.
